(19) United States
(12) Patent Application Publication
(10) Pub. No.: US 2017/0016712 A1
(43) Pub. Date: Jan. 19, 2017

(54) POSITION MEASUREMENT SYSTEM

(71) Applicant: TOYOTA JIDOSHA KABUSHIKI KAISHA, Toyota-shi (JP)

(72) Inventor: Tomohiro SUZUKI, Nagakute-shi (JP)

(73) Assignee: TOYOTA JIDOSHA KABUSHIKI KAISHA, Toyota-shi (JP)

(21) Appl. No.: 15/174,238

(22) Filed: Jun. 6, 2016

(30) Foreign Application Priority Data
Jul. 14, 2015 (JP) 2015-140328

(51) Int. Cl. G01B 11/00; B25J 9/16; G01B 11/14

(52) U.S. Cl. CPC G01B 11/002; G01B 11/14; B25J 9/1692; G05B 2219/39033

(57) ABSTRACT

A teaching system (position measurement system) includes a plurality of reflectors provided on a tip of a robot arm, and a measuring device. The measuring device measures a present position of the tip of the robot arm by using reflected light on the reflectors, the reflected light being obtained after irradiation light applied to the reflectors is reflected. The plurality of reflectors each reflect, toward the measuring device, the irradiation light applied from the measuring device located in a direction within a predetermined incidence area. The plurality of reflectors are provided at the tip of the robot arm in such a manner that central directions of the incidence areas of the reflectors are different from each other.

### INCORPORATION BY REFERENCE

This application is based upon and claims the benefit of priority from Japanese patent application No. 2015-140328, filed on Jul. 14, 2015, the disclosure of which is incorporated herein in its entirety by reference.

### BACKGROUND OF THE INVENTION

1. Field of the Invention

The present invention relates to a position measurement system, and more particularly, to a position measurement system that measures a position of a measurement target of a robot arm.

2. Description of Related Art

At a production site (actual production line) for a vehicle body or the like, a predetermined operation, such as welding, is performed using a robot arm, such as an industrial robot. The robot arm is operated to reach a desired position or posture by reproducing teaching data programmed by robot teaching.

In recent years, robot teaching has been carried out in many cases by off-line teaching that is virtually performed on a computer, such as a personal computer, without using a real machine. In the case of using an actual robot to reproduce off-line teaching data obtained by off-line teaching, a deviation (difference) between the actual position (present position) of the robot arm and the target position corresponding to the off-line teaching data occurs. This positional deviation is caused by, for example, a deformation of the robot arm due to gravity, or a difference in precision between products (workpieces). Accordingly, it is necessary to correct (modify, revise, or calibrate) the positional deviation on the actual production line. However, in this case, much time and labor is required to manually perform this position correction process. Therefore, there is a demand for automatically performing the position correction process.

In association with this technique, Japanese Unexamined Patent Application Publication No. 2002-103259 discloses a robot teaching method using a laser measuring instrument. Specifically, Japanese Unexamined Patent Application Publication No. 2002-103259 discloses a method for generating coordinates of an end of a lower tip of a welding gun of a welding robot by irradiating a reflector, which is placed on the end of the lower tip of the welding gun, with a laser beam from the laser measuring instrument (laser measuring device) and calculating a distance to the reflector by calculating the wavelength of the laser beam, which is reflected back to the sensor head of the laser measuring instrument, over time. Thus, the position correction process is carried out. At this time, the irradiation direction of the laser beam can be changed by, for example, moving the head portion of the laser measuring instrument. Accordingly, even when the reflector performs a translational movement along with the movement of the end of the lower tip of the welding gun, the reflector placed on the tip of the welding gun can be irradiated with a laser beam by changing the irradiation direction of the laser beam.

### SUMMARY OF THE INVENTION

The reflector that reflects a laser beam (laser light) is required to reflect the laser light incident from a certain direction in the same direction as that of the certain direction. In this case, it is known that if the reflector that reflects a laser beam (laser light) is configured to be able to reflect the laser light applied from all directions, the precision in position measurement of the reflector significantly deteriorates. Accordingly, in order to maintain the precision in position measurement, the area (incidence area) of the direction (angle) in which the reflector reflects the laser light incident on the reflector is limited to within a predetermined range.

When the laser measuring device is located in the direction within the incidence area of the reflector mounted on the measurement target of the robot arm (for example, on the tip of the robot arm), that is, when the incidence area of the reflector faces the laser measuring device, the direction of the laser light is adjusted in the laser measuring device so that the laser light applied from the laser measuring device is made incident on the reflector. In this case, the reflector can reflect the laser light on the laser measuring device, which makes it possible to perform the position measurement. On the other hand, the position and posture of the robot arm may greatly vary depending on the content of the operation when the process shifts from a certain operation step to the subsequent operation step. In this case, the reflector mounted on the measurement target of the robot arm may move from a state where the incidence area of the reflector is located in the direction of the laser measuring device to a state where the incidence area of the reflector is not located in the direction of the laser measuring device. In other words, the irradiation direction of the laser light (i.e., the direction of the laser measuring device as viewed from the reflector) may deviate from the incidence area of the reflector. To put it another way, there is a possibility that the incidence area of the reflector does not face the laser measuring device. In this case, even when the direction of the laser light is adjusted in the laser measuring device, the laser light is not incident on the reflector, with the result that the laser light may not be reflected by the reflector. Thus, there is a possibility that the position of the robot arm cannot be measured when the robot arm is in a certain posture. This problem will be described in detail below with reference to the drawings.

FIG. 13 is a diagram for explaining a state where the irradiation direction of the laser light deviates from the incidence area of the reflector. FIG. 13 illustrates only the vicinity of a tip of a robot arm 2. During the position measurement, one reflector 100 is placed on a tip 2a of the robot arm 2. The reflector 100 is, for example, a laser reflector, and is configured to reflect (perform recursive reflection) in substantially the same direction as the direction in which laser light incident from a certain direction is made incident. The reflector 100 includes a mirror portion 102 (reflecting portion) composed of a plurality of mirror reflectors. In the reflector 100, an incidence area 110 which is an area in which laser light can be made incident and reflected on the mirror portion 102 is determined in advance.

A measuring device 20 is provided in the vicinity of the robot arm 2 during the position correction process. The measuring device 20 measures the position of the tip 2a of the robot arm. A head portion 20a of the measuring device 20 is rotatable in the horizontal direction (azimuth direction) and the vertical direction (elevation angle direction). The head portion 20a is provided with a laser light source 202. The measuring device 20 measures the position of the tip 2a by irradiating the reflector 100 with laser light from the laser light source 202 and receiving the reflected light reflected on the reflector 100. Even in a case where the reflector 100 has moved, the measuring device 20 can change the direction (the horizontal angle and the elevation angle) of the head portion 20a by following the movement of the reflector 100, and thus can continuously irradiate the reflector 100 with a laser beam La.

In this case, in a state (a), the robot arm 2 is in such a posture that the incidence area 110 of the reflector 100 is located in the direction of the measuring device 20. In other words, in the state (a), the measuring device 20 is located in the direction within the incidence area 110 of the reflector 100. To put it another way, in the sate (a), the incidence area 110 of the reflector 100 faces the measuring device 20. In this case, the measuring device 20 adjusts the direction of the head portion 20a, thereby allowing the laser beam La to be made incident in the incidence area 110 of the reflector 100. At this time, since the reflector 100 can reflect the incident laser beam La toward the measuring device 20, the measuring device 20 can perform the position measurement.

On the other hand, assume that the state of the tip 2a becomes a state (b) as a result of a change in the posture of the robot arm 2. In this state, the incidence area 110 of the reflector 100 is not located in the direction of the measuring device 20. In other words, in the state (b), the incidence area 110 of the reflector 100 does not face the measuring device 20. Further, in the state (b), the irradiation direction of the laser beam La deviates from the incidence area 110 of the reflector 100. Even if the direction of the head portion 20a of the measuring device 20 is adjusted in this state, the laser beam La cannot be made incident in the incidence area 110 of the reflector 100. Accordingly, when the state of the tip 2a becomes the state (b) as a result of a change in the posture of the robot arm 2, the measuring device 20 cannot perform the position measurement. In other words, in the case of setting the incidence area 110 in the reflector 100 to maintain the precision of the position measurement, instead of applying laser light from all directions, the laser beam La is not made incident in the incidence area 110 of the reflector 100 in some cases depending on the posture of the robot arm 2, which makes it difficult to perform the position measurement.

An object of the present invention is to provide a position measurement system capable of measuring a position of a robot arm, regardless of the posture of the robot arm, while maintaining the precision of the position measurement.

A first exemplary aspect of the present invention is a positioning measurement system that measures a position of a measurement target of a robot arm, the positioning measurement system including: a measuring instrument including a plurality of reflectors, the measuring instrument being provided on the measurement target of the robot arm; and a measuring device that measures the position of the measurement target of the robot arm by using reflected light on the reflectors, the reflected light being obtained after irradiation light applied to the reflectors is reflected. The plurality of reflectors each reflect, toward the measuring device, the irradiation light applied from the measuring device located in a direction within a predetermined incidence area, and the measuring instrument is provided with the plurality of reflectors in such a manner that central directions of the incidence areas of the reflectors are different from each other. An area obtained by combining the incidence areas of the plurality of reflectors covers all directions around the measuring instrument, or covers an area excluding at least a part of an area in which the incidence area of each of the reflectors cannot be set in the direction of the measuring device due to limitations of a working area of the robot arm.

According to the above-described configuration of the present invention, it is possible for any one of the plurality of reflectors to reflect the irradiation light, regardless of the posture of the measurement target of the robot arm within the working area, even when the reflectors having an incidence area in which the precision of the position measurement can be maintained are used. Therefore, according to the present invention, it is possible to measure the position of the robot arm, regardless of the posture of the robot arm, while maintaining the precision of the position measurement.

Preferably, when two or more of the plurality of reflectors reflect the irradiation light, the measuring device measures the present position of the measurement target by using the reflected light having the strongest intensity among a plurality of reflected light beams.

When the position measurement is performed using the reflected light, the stronger the intensity of the reflected light is, the more the precision of the position measurement improves. Therefore, according to the present invention, it is possible to measure the present position of the measurement target with a higher precision.

Preferably, the measuring device measures the position of each of the reflectors using the reflected light from the reflectors, identifies the reflector whose position is measured, and measures the position of the measurement target according to a positional relationship between the identified reflector and the measurement target.

According to the above-described configuration of the present invention, it is possible to measure the position of the measurement target by using the reflected light from the reflectors even when the irradiation light is reflected on any one of the plurality of reflectors.

According to the present invention, it is possible to provide a position measurement system capable of measuring a position of a robot arm, regardless of the posture of the robot arm, while maintaining the precision of the position measurement.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a diagram showing a teaching system according to a first exemplary embodiment;

FIG. 2 is a conceptual diagram showing a measuring instrument according to the first exemplary embodiment;

FIG. 3 is a diagram for explaining a method for measuring a position of a reflector according to the first exemplary embodiment;

FIG. 4 is a diagram showing details of the measuring instrument according to the first exemplary embodiment;

FIG. 5 is a functional block diagram showing configurations of a measuring device and an arithmetic unit according to the first exemplary embodiment;

FIG. 6 is a flowchart showing a method for performing a position correction process using the teaching system according to the first exemplary embodiment;

FIG. 7 is a flowchart showing a measurement process according to the first exemplary embodiment;

FIG. 8 is a table showing a relationship among a supporting surface, an interval of blinking of a luminous body placed on the supporting surface, and a reflector;

FIG. 9 is a flowchart showing a comparison process according to the first exemplary embodiment;

FIG. 10 is a diagram illustrating results of the comparison process;

FIG. 11 is a diagram for explaining an area in which laser light can be made incident on the entire measurement instrument according to the first exemplary embodiment;

FIG. 12 is a diagram for explaining an area in which laser light can be made incident on the entire measurement instrument according to a modified example; and

FIG. 13 is a diagram for explaining a state where an irradiation direction of laser light deviates from an incidence area of a reflector.

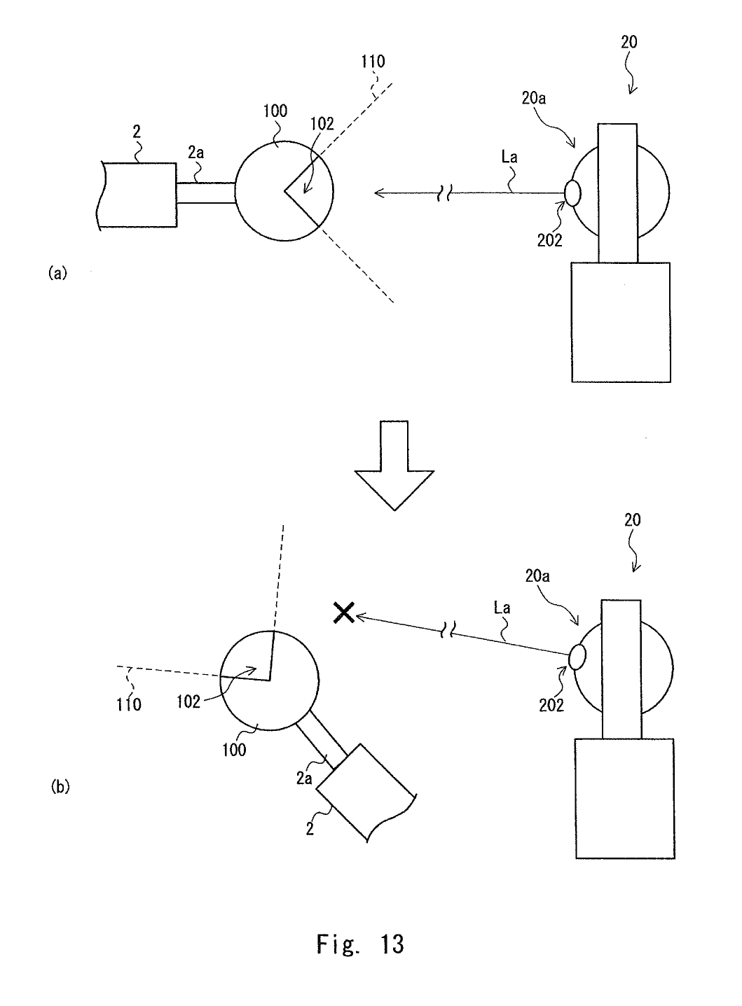

### DESCRIPTION OF THE EXEMPLARY EMBODIMENTS

### First Exemplary Embodiment

Exemplary embodiments of the present invention will be described below with reference to the drawings.

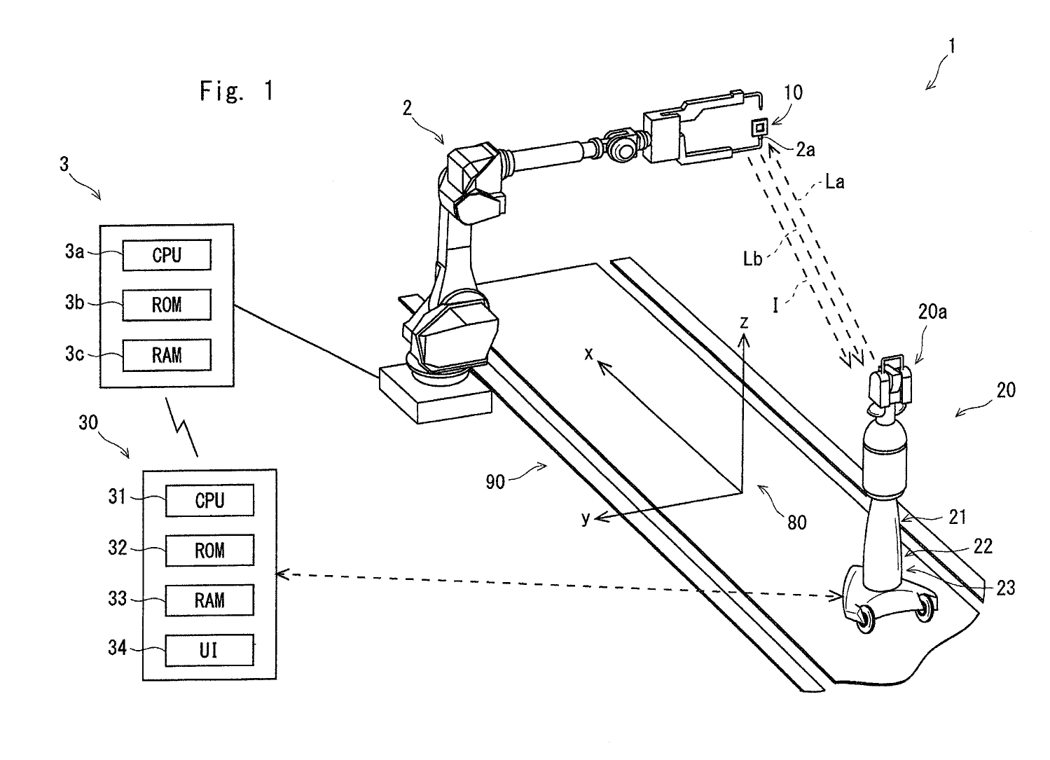

FIG. 1 is a diagram showing a teaching system 1 according to a first exemplary embodiment. The teaching system 1 (position measurement system) includes a robot arm 2, a control device 3, a measuring instrument 10, a measuring device 20, and an arithmetic unit 30. The teaching system 1 is used to teach the operation of the robot arm 2. The teaching system 1 functions as a position measurement system that measures a position of a measurement target of the robot arm 2 by the above-mentioned structure. The teaching system 1 also functions as a position correction system that corrects the position according to the difference between the measured present position of the robot arm 2 and a target position thereof by using the above-mentioned structure.

The robot arm 2 is placed in the vicinity of a production line 90 for vehicles. The robot arm 2 is, for example, a robot for performing a predetermined operation, such as welding (e.g., spot welding), on vehicles. For example, during the production of vehicles, the robot arm 2 performs welding or the like by using a welding gun or the like which is provided at a tip 2a. The robot arm 2 includes at least one joint and a motor that drives the joint. The control device 3 controls the motor to thereby allow the robot arm 2 to perform a desired operation.

Further, in the case of performing a position correction process, the measurement instrument 10 is attached to the tip 2a which is the measurement target. The measuring instrument 10 is used to measure a present position (x, y, and z; hereinafter referred to as the “present position”) and a present posture (roll, pitch, and yaw; hereinafter referred to as the “present posture”) of the tip 2a. This will be described in detail later. The measurement target is not limited to the tip 2a of the robot arm 2. The “position correction process” described herein includes not only a process for correcting (calibrating) the difference (machine difference) between the target position and the present position, but also a process for correcting the difference between the target posture and the present posture.

The control device 3 controls the operation of the robot arm 2. In other words, the control device 3 functions as control means for controlling the robot arm 2. The control device 3 functions as, for example, a computer. The control device 3 may be mounted in the robot arm 2, or may be connected to the robot arm 2 so that they are able to communicate with each other via a wire or wirelessly. The control device 3 includes a CPU (Central Processing Unit) 3a, a ROM (Read Only Memory) 3b, and a RAM (Random Access Memory) 3c. The CPU 3a functions as a processing device that performs control processing, arithmetic processing, and the like. The ROM 3b has a function for storing a control program, an arithmetic program, and the like to be executed by the CPU 3a. The RAM 3c has a function for temporarily storing processed data and the like. The functions of the CPU, the ROM, and the RAM to be described later are the same as those of the CPU 3a, the ROM 3b, and the RAM 3c.

In this case, the ROM 3b is configured to be able to store off-line teaching data (off-line teaching program) generated by off-line teaching. The control device 3 controls the tip 2a of the robot arm 2 to a desired position (x, y, and z; hereinafter referred to as a “target position”) and a desired posture (roll, pitch, and yaw; hereinafter referred to as a “target posture”) according to the off-line teaching data. Upon receiving correction data indicating a correction amount from the arithmetic unit 30, the control device 3 controls the position and the posture of the tip 2a to be the target position and the target posture, respectively, by taking into consideration the correction amount. Thus, the position correction process is carried out.

The measuring device 20 is placed on the production line 90 or in the vicinity of the production line 90 during the position correction process. The measuring device 20 measures the present position and the present posture of the tip 2a of the robot arm 2. In other words, the measuring device 20 (or the components of the measuring device 20 as described later) functions as measurement means for measuring the present position and the present posture of the tip 2a. Specifically, a head portion 20a which is provided at an upper portion of the measuring device 20 irradiates the measuring instrument 10, which is attached to the tip 2a, with a laser beam La (irradiation light), and receives reflected light Lb from the measuring instrument 10. The head portion 20a of the measuring device 20 receives infrared light I emitted from the measuring instrument 10. The measuring device 20 measures the present position and the present posture of the tip 2a by using the received reflected light Lb and infrared light I. This will be described in detail later. The measuring device 20 also includes a CPU 21, a ROM 22, and a RAM 23, and performs processes as described later. In other words, the measuring device 20 functions as, for example, a computer. The measuring device 20 may not be placed during the production of vehicles and the like on the production line 90 (online).

The arithmetic unit 30 functions as, for example, a computer. The arithmetic unit 30 includes a CPU 31, a ROM 32, a RAM 33, and a UI (User Interface) 34. The UI 34 is composed of, for example, an input device, such as a keyboard, and an output device, such as a display. The UI 34 may be configured as a touch panel which includes an input device and an output device that are integrated with each other. The arithmetic unit 30 compares the present position and the present posture, which are measured by the measuring device 20, with the target position and the target posture, respectively, and calculates a correction amount. In other words, the arithmetic unit 30 (or the components of the arithmetic unit 30 as described later) functions as correction amount calculating means for calculating a correction amount. This will be described in detail later. The arithmetic unit 30 is connected with the measuring device 20 so that they are able to communicate with each other via a wire or wirelessly. Similarly, the arithmetic unit 30 is connected with the control device 3 so that they are able to communicate with each other via a wire or wirelessly. The arithmetic unit 30 may be integrated with the measuring device 20. In other words, the function of the arithmetic unit 30 may be implemented by the measuring device 20.

A reference coordinate system representing the target position in the off-line teaching data and a reference coordinate system representing the present position measured by the measuring device 20 are based on a vehicle that is assumed to be placed on the production line 90. Specifically, as shown in FIG. 1, a reference coordinate system 80 (line coordinates) representing the target position and the present position in the three-dimensional space is set such that the most forward position of the vehicle is represented by x=0 and the direction from the front side to the back side of the vehicle corresponds to the forward direction of the x-axis. Further, as shown in FIG. 1, the reference coordinate system 80 is set such that the center of the vehicle in the width direction thereof is represented by y=0 and the direction from the center of the vehicle in the width direction thereof to the right of the vehicle (rightward when the front side of the vehicle is viewed from the back side thereof) corresponds to the forward direction of the y-axis. Furthermore, as shown in FIG. 1, the reference coordinate system 80 is set such that the ground position of the vehicle is represented by z=0 and the vertically upward direction corresponds to the forward direction of the z-axis. That is, the reference coordinate system 80 has an origin O which corresponds to the most forward position of the vehicle in the front-back direction thereof, the center position of the vehicle in the width direction thereof, and the ground position of the vehicle in the vertical direction. When the position correction process is performed, the vehicle is not placed on the production line 90 in practice. Accordingly, the origin O, the x-axis, the y-axis, and the z-axis of the reference coordinate system 80 can be determined based on a carriage (pallet) on which the vehicle is placed during the manufacturing process.

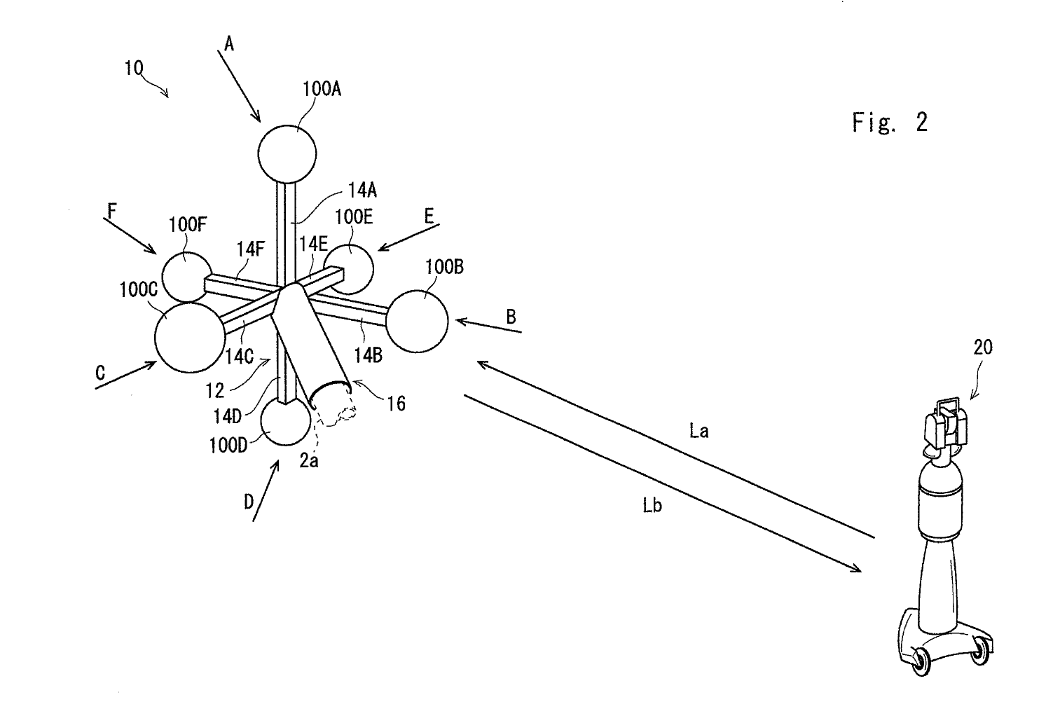

FIG. 2 is a conceptual diagram showing the measuring instrument 10 according to the first exemplary embodiment. The measuring instrument 10 includes a plurality of reflectors 100 and a frame 12 that supports the plurality of reflectors 100. Preferably, the measuring instrument 10 includes, for example, six reflectors 100A, 100B, 100C, 100D, 100E, and 100F. However, the number of the reflectors 100 is not limited to six. In the following description, assume that the number of the reflectors 100 is six. Each reflector 100 is, for example, a laser reflector, and is configured to reflect (perform recursive reflection) in substantially the same direction as the direction in which laser light incident from a certain direction is made incident. Each reflector 100 is, for example, a corner cube, a corner reflector, or a retroreflector. However, the type of each reflector 100 is not limited to these reflectors.

When the reflectors 100A, 100B, 100C, 100D, 100E, and 100F are described without distinguishing them from each other, the reflectors are collectively referred to as the reflector 100. The same applies to the other components.

The frame 12 includes a plurality of support portions 14 which face in different directions. The number of the support portions 14 is the same as the number of the reflectors 100. Specifically, the frame 12 includes support portions 14A, 14B, 14C, 14D, 14E, and 14F. The reflectors 100A, 100B, 100C, 100D, 100E, and 100F are supported by the support portions 14A, 14B, 14C, 14D, 14E, and 14F, respectively.

The frame 12 is provided with an attachment member 16 that is used to attach the measuring instrument 10 to the tip 2a of the robot arm 2. The attachment member 16 is connected to the tip 2a, thereby fixing the measuring instrument 10 to the tip 2a. In other words, the measuring instrument 10 is integrated with the tip 2a. Thus, the plurality of reflectors 100 move in synchronization with the movement of the tip 2a. With this configuration, the positional relationships of the plurality of reflectors 100 relative to the tip 2a become constant. That is, each of the plurality of reflectors 100 has a predetermined positional relationship with respect to the tip 2a. In other words, if the position and posture (direction; spatial angle) of the reflector 100 are determined, the position and posture of the tip 2a are uniquely determined.

The measuring device 20 irradiates the measuring instrument 10 (the plurality of reflectors 100) configured as shown in FIG. 2 with the laser beam La (irradiation light), and receives the reflected light Lb from any one or more of the plurality of reflectors 100. The measuring device 20 measures the position of the tip 2a by using the reflected light Lb.

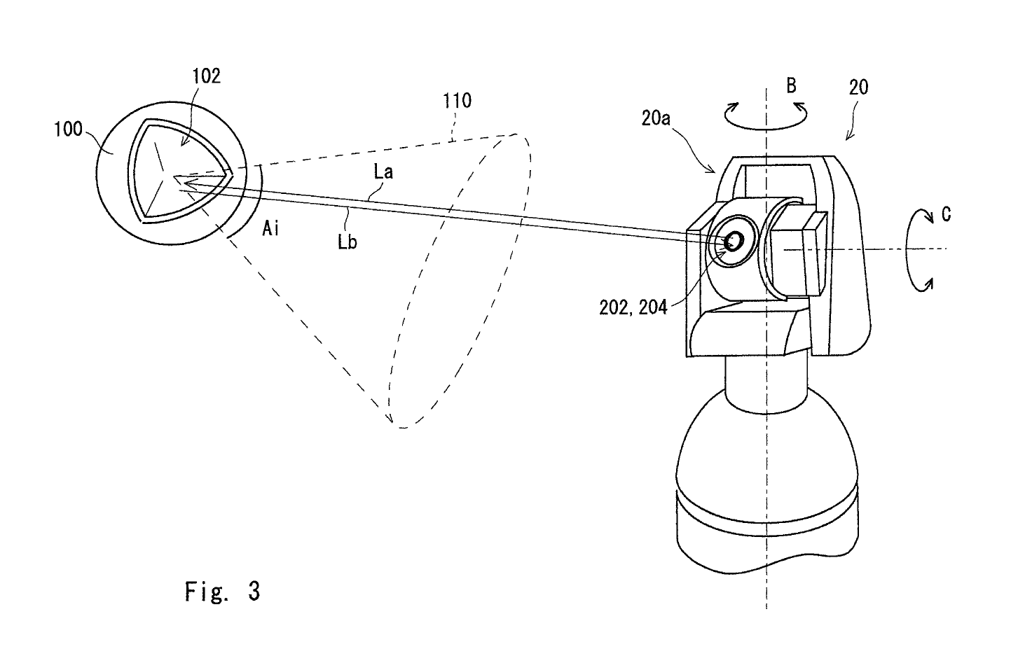

FIG. 3 is a diagram for explaining a method for measuring the position of each reflector 100 according to the first exemplary embodiment. As shown in FIG. 3, the reflector 100 includes a mirror portion 102 (reflecting portion) composed of a plurality of mirror reflectors. In the reflector 100, an incidence area 110 which is an area in which the laser light can be made incident and reflected on the mirror portion 102 is determined in advance. The incidence area 110 can be formed with a conical surface. As described above, if an angle Ai (cone angle) of the incidence area 110 is set in all directions, the precision in the position measurement deteriorates. For this reason, the angle Ai of the incidence area 110 in the reflector 100 is set in a narrower area rather than in all directions. In other words, the mirror portion 102 is formed on a surface of a part of the reflector 100, and is not formed on the entire surface (in all directions) of the reflector 100. The term “the direction of the reflector 100” described herein refers to a direction in which the mirror portion 102 is provided at the periphery of the reflector 100, or a direction in which the incidence area 110 is provided. In the first exemplary embodiment, the angle Ai of the incidence area 110 can be set in a range of, for example, ±45 degrees to ±60 degrees, on both sides of the center of the incidence area 110 (i.e., Ai=90 degrees to 120 degrees). However, the angle of the incidence area is not limited to this.

The head portion 20a of the measuring device 20 is rotatable in the horizontal direction (azimuth direction) as indicated by an arrow B. Similarly, the head portion 20a of the measuring device 20 is rotatable in the vertical direction (elevation angle direction) as indicated by an arrow C. The head portion 20a includes a laser light source 202 and a reflected laser light receiving unit 204. The laser light source 202 applies the laser beam La to the reflector 100. In this case, even in a case where the reflector 100 has moved, if the rate of movement of the reflector 100 is within a certain range, the measuring device 20 can change the direction (the horizontal angle and the elevation angle) of the head portion 20a by following the movement of the reflector 100, and thus can continuously irradiate the reflector 100 with the laser beam La.

The laser beam La applied from the measuring device 20 is incident on the mirror portion 102 of the reflector 100. The mirror portion 102 of the reflector 100 reflects the incident laser beam toward the measuring device 20. Thus, the reflected light Lb on the reflector 100 is received by the measuring device 20. In other words, each of the plurality of reflectors 100 reflects the laser beam La, which is applied from the measuring device 20 located in the direction of the incidence area 110, toward the measuring device 20.

Specifically, when the laser beam La falls within the incidence area 110 of a certain reflector 100 (for example, the reflector 100A), the reflector 100 (for example, the reflector 100A) reflects the laser beam in substantially the same direction as the direction in which the laser beam La is made incident. Thus, the reflected laser light receiving unit 204 of the measuring device 20 receives the reflected light Lb from the reflector 100. The measuring device 20 can calculate the distance to the reflector 100 by using a phase difference (interference) between the irradiated laser beam La and the reflected light Lb. Further, the measuring device 20 can obtain the direction of the laser beam La (and the reflected light Lb) with respect to the head portion 20a, i.e., the direction of the reflector 100, from the direction (the horizontal angle and the elevation angle) of the head portion 20a. Thus, the measuring device 20 can measure the position (coordinates) of the reflector 100 in the three-dimensional space (xyz coordinate system) based on the head portion 20a. Similarly, the measuring device 20 can measure the position of the origin O of the reference coordinate system 80 shown in FIG. 1. Accordingly, the measuring device 20 can measure the position of the reflector 100 in the reference coordinate system 80 by converting the coordinates into the reference coordinate system 80 from the coordinate system based on the head portion 20a.

As described above, each of the plurality of reflectors 100 has a predetermined positional relationship with respect to the tip 2a. Accordingly, if the position and direction (posture) of a certain reflector 100 can be measured, the position and direction (posture) of the tip 2a can be measured. In this case, the plurality of reflectors 100 are placed in such a manner that the mirror portions 102 of the respective reflectors 100 face in different directions. In other words, the plurality of reflectors 100 are provided at the tip 2a of the robot arm 2 in such a manner that the directions of the incidence areas 110 of the reflectors 100 are different from each other. To put it another way, the plurality of reflectors 100 are provided at the tip 2a of the robot arm 2 in such a manner that a certain reflector (for example, the reflector 100B) is located in a direction outside the incidence area 110 of another reflector 100 (for example, the reflector 100A).

Thus, regardless of the posture of the tip 2a of the robot arm 2, any one of the plurality of reflectors 100 provided on the measuring instrument 10 can reflect the laser beam La from the measuring device 20. In other words, the plurality of reflectors 100 are configured in such a manner that the laser beam La enters the incidence area 110 of any one of the plurality of reflectors 100, regardless of the irradiation direction of the laser beam La. For example, depending on the posture of the tip 2a, when the laser beam La is applied from a direction indicated by an arrow A as shown in FIG. 2, the reflector 100A reflects the laser beam La. Similarly, depending on the posture of the tip 2a, when the laser beam La is applied from a direction indicated by an arrow B, the reflector 100B reflects the laser beam La; when the laser beam La is applied from a direction indicated by an arrow C, the reflector 100C reflects the laser beam La; when the laser beam La is applied from a direction indicated by an arrow D, the reflector 100D reflects the laser beam La; when the laser beam La is applied from a direction indicated by an arrow E, the reflector 100E reflects the laser beam La; and when the laser beam La is applied from a direction indicated by an arrow F, the reflector 100F reflects the laser beam La. Thus, the measuring device 20 according to the first exemplary embodiment can appropriately measure the position of the tip 2a, regardless of the posture of the tip 2a of the robot arm 2.

If only one reflector 100 is provided at the tip 2a, the direction of the laser beam La may significantly deviate from the incidence area 110 of the reflector 100 as a result of a significant change in the posture of the tip 2a. In this case, the reflector 100 cannot reflect the laser beam La, which makes it difficult for the measuring device 20 to measure the position of the tip 2a. Further, in order for the measuring device 20 to measure the position of the tip 2a in this case, it is necessary to move the measuring device 20 so that the laser beam La enters the incidence area 110 of the reflector 100. However, the operation of moving the measuring device 20 every time the posture of the tip 2a of the robot arm 2 changes is extremely troublesome. On the other hand, in the first exemplary embodiment, regardless of the posture of the tip 2a of the robot arm 2, the position of the tip 2a can be measured without the need to move the measuring device 20. Accordingly, in the first exemplary embodiment, the position of the tip 2a can be measured effectively.

Even when the irradiation direction of the laser beam La slightly deviates from the incidence area 110 of the reflector 100, the reflector 100 may reflect the laser beam La. However, the use of the reflected light Lb of the laser beam La applied from a direction outside the incidence area 110 causes a decrease in the intensity of the reflected light Lb and deterioration in the precision of the position measurement. Accordingly, it is preferable to perform the position measurement using the reflected light Lb of the laser beam La that enters the incidence area 110 and is reflected by the reflector 100. In the first exemplary embodiment, the reflectors 100 are configured in such a manner that the laser beam La enters the incidence area 110 of any one of the plurality of reflectors 100, regardless of the irradiation direction of the laser beam La. Therefore, in the first exemplary embodiment, the position of each reflector 100, i.e., the position of the tip 2a, can be measured with a high precision.

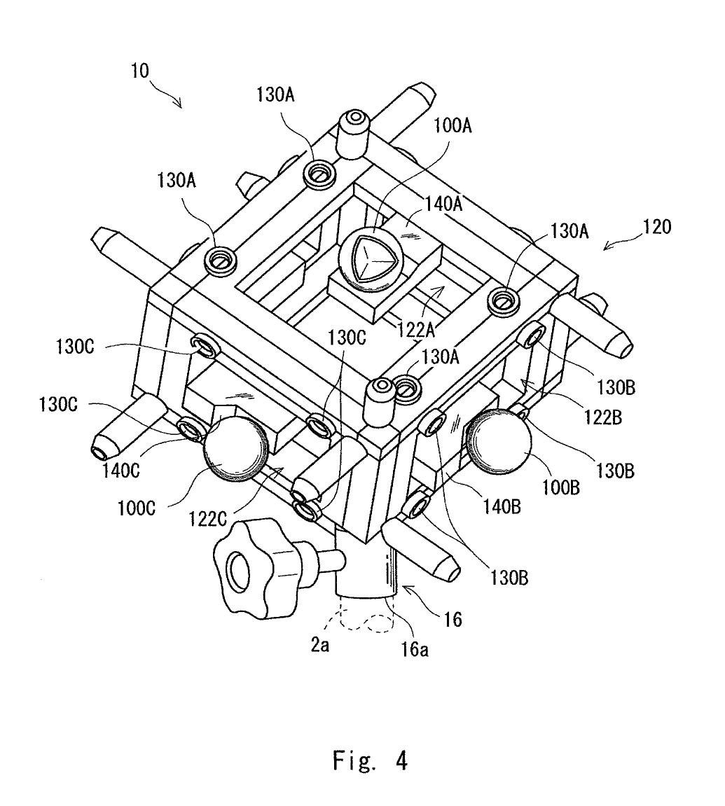

FIG. 4 is a diagram showing details of the measuring instrument 10 according to the first exemplary embodiment. The measuring instrument 10 includes a plurality of reflectors 100 and a support member 120 that supports the plurality of reflectors 100. The support member 120 corresponds to the frame 12 shown in FIG. 2. FIG. 4 illustrates only three reflectors 100, i.e., the reflector 100A, 100B, and 100C. However, in practice, the measuring instrument 10 includes six reflectors 100 (reflectors 100A, 100B, 100C, 100D, 100E, and 100F) as shown in FIG. 2.

The support member 120 is formed in a substantially hexahedral shape. Preferably, the support member 120 is formed in a regular hexahedron (cube). Six supporting surfaces 122 of the support member 120 are respectively provided with reflector support members 140 that support the respective reflectors 100. For example, a reflector support member 140A provided on a supporting surface 122A supports the reflector 100A. Similarly, a reflector support member 140B provided a supporting surface 122B supports the reflector 100B, and a reflector support member 140C provided on a supporting surface 122C supports the reflector 100C.

In this case, the supporting surfaces 122 and the reflector support members 140 correspond to the support portions 14 shown in FIG. 2. Specifically, the plurality of supporting surfaces 122 and the plurality of reflector support members 140 support the respective reflectors 100 in such a manner that the corresponding one of the supporting surfaces 122 and the corresponding one of the reflector support members 140 face in different directions. Accordingly, the plurality of reflectors 100 are provided in such a manner that central directions of the incidence areas 110 of the respective reflectors are different from each other. In other words, the plurality of reflectors 100 are configured in such a manner that the incidence area 110 of a certain reflector (for example, the reflector 100B) is provided in a direction outside the incidence area 110 of another reflector 100 (for example, the reflector 100A). Thus, regardless of the posture of the robot arm 2, the incidence area 110 of at least one of the plurality of reflectors 100 faces the measuring device 20 (that is, the incidence area 110 of at least one reflector 100 is located in the direction of the measuring device 20).

FIG. 4 illustrates only the three supporting surfaces 122 (supporting surfaces 122A, 122B, and 122C). However, in practice, the measuring instrument 10 includes six supporting surfaces 122 (supporting surfaces 122A, 122B, 122C, 122D, 122E, and 122F) as shown in FIG. 2. Similarly, the measuring instrument 10 includes six reflector support members 140 (reflector support members 140A, 140B, 140C, 140D, 140E, and 140F) respectively corresponding to the six supporting surfaces 122 (supporting surfaces 122A, 122B, 122C, 122D, 122E, and 122F).

The support member 120 is provided with the attachment member 16 that is used to attach the measuring instrument 10 to the tip 2a of the robot arm 2. The attachment member 16 is connected to the tip 2a, thereby fixing the measuring instrument 10 to the tip 2a. Accordingly, as described above, each of the plurality of reflectors 100 has a predetermined positional relationship relative to the tip 2a. In other words, if the position and posture (direction; spatial angle) of the reflector 100 are determined, the position and posture of the tip 2a are uniquely determined.

To put it another way, the position of the reflector 100 relative to an attachment position 16a of the attachment member 16 where the tip 2a is to be attached is constant regardless of the position and posture of the tip 2a. For example, the distance from the attachment position 16a to the reflector 100A is constant, and the direction of the reflector 100A as viewed from the attachment position 16a is also constant. Accordingly, if the position and posture of the reflector 100 are measured, the position and posture of the tip 2a can be measured.

The six supporting surfaces 122 of the support member 120 are each provided with a plurality of luminous bodies 130 that emit infrared light. Each luminous body 130 is, for example, an LED (Light Emitting Diode), but is not limited to this. In the first exemplary embodiment, each supporting surface 122 is provided with four luminous bodies 130. In other words, the measuring instrument 10 is provided with 24 (4×6) luminous bodies 130. For example, the supporting surface 122A is provided with four luminous bodies 130A. Similarly, the supporting surface 122B is provided with four luminous bodies 130B, and the supporting surface 122C is provided with four luminous bodies 130C. On each supporting surface 122, the corresponding reflector 100 is located at the position corresponding to the intersection of the diagonal lines connecting the four luminous bodies 130 (i.e., in the center of the four luminous bodies 130).

The measuring device 20 receives the infrared light from these luminous bodies 130, thereby making it possible to measure the direction (posture; spatial angle) of each supporting surface 122. Thus, the measuring device 20 can measure the posture of each reflector 100 that is supported by the corresponding supporting surface 122 (reflector support member 140). This configuration enables the measuring device 20 to measure the posture (roll, pitch, and yaw) of the tip 2a of the robot arm 2.

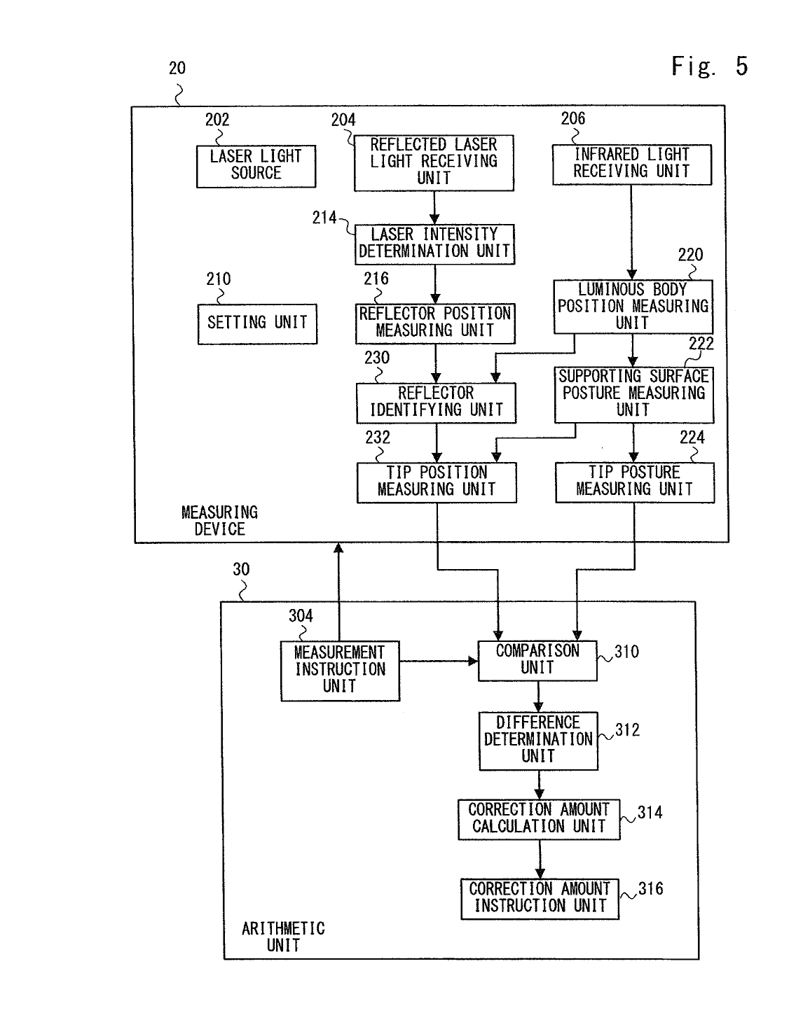

FIG. 5 is a functional block diagram showing the configurations of the measuring device 20 and the arithmetic unit 30 according to the first exemplary embodiment. The measuring device 20 includes the laser light source 202, the reflected laser light receiving unit 204, an infrared light receiving unit 206, a setting unit 210, a laser intensity determination unit 214, a reflector position measuring unit 216, a luminous body position measuring unit 220, a supporting surface posture measuring unit 222, a reflector identifying unit 230, a tip position measuring unit 232, and a tip posture measuring unit 224. The arithmetic unit 30 includes a measurement instruction unit 304, a comparison unit 310, a difference determination unit 312, a correction amount calculation unit 314, and a correction amount instruction unit 316. The functions of the components of the measuring device 20 and the arithmetic unit 30 will be described later.

The components of the measuring device 20 and the arithmetic unit 30 can be implemented by, for example, causing the CPU to execute a program stored in the ROM. Necessary programs may be stored in any nonvolatile storage medium and may be installed as needed. The components may be implemented not only by software as described above, but also by hardware such as any circuit element.

At least one of (or all) the components of the arithmetic unit 30 shown in FIG. 5 may be implemented by the measuring device 20. Otherwise, at least one of the components (or the components other than the laser light source 202, the reflected laser light receiving unit 204, and the infrared light receiving unit 206) of the measuring device 20 shown in FIG. 5 may be implemented by the arithmetic unit 30. In this case, the arithmetic unit 30 can function as measurement means (measuring device).

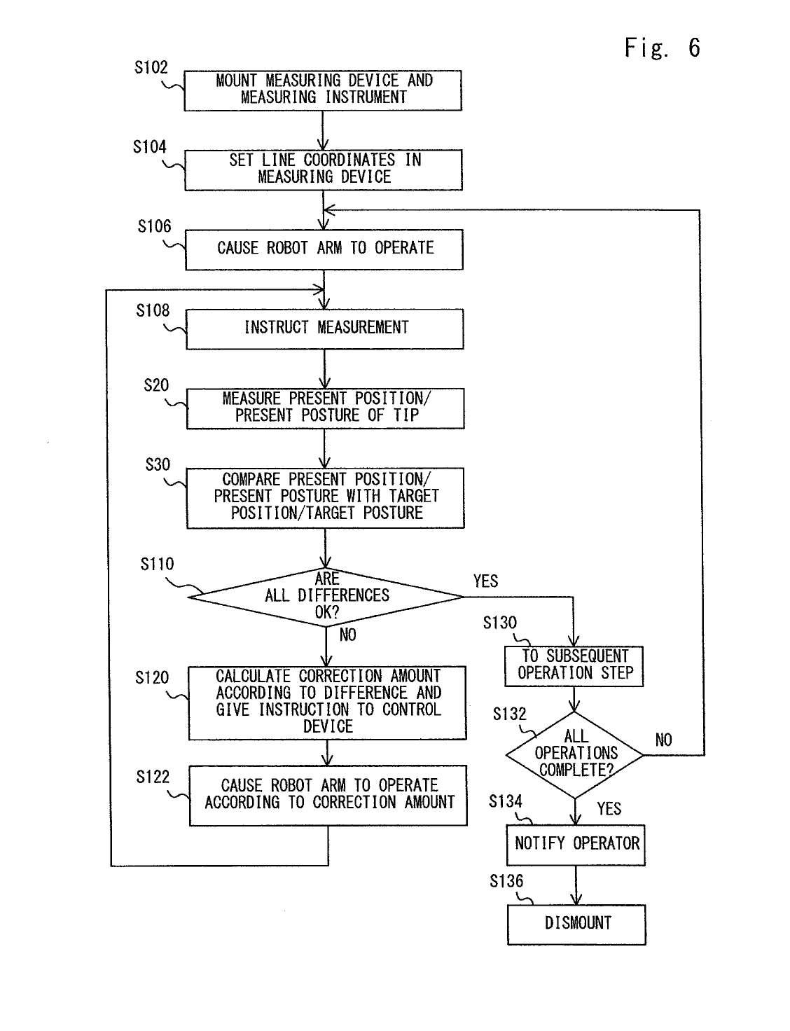

FIG. 6 is a flowchart showing a method for performing the position correction process using the teaching system 1 according to the first exemplary embodiment. First, the measuring device 20 and the measuring instrument 10 are mounted (step S 102). Specifically, the measuring device 20 is placed on the production line 90 or in the vicinity of the production line 90. The measuring instrument 10 is attached to the tip 2a which is the measurement target.

Next, the reference coordinate system 80 (line coordinates) is set in the measuring device 20 (step S104). Specifically, the setting unit 210 of the measuring device 20 sets the origin O, the x-axis, the y-axis, and the z-axis of the reference coordinate system 80. This enables the measuring device 20 to measure the position coordinates in the reference coordinate system 80.

The setting unit 210 associates the posture (direction, angle) of each supporting surface 122 of the measuring instrument 10 with the posture (roll, pitch, and yaw) of the tip 2a. Further, the setting unit 210 sets the positional relationship of each of the plurality of reflectors 100 relative to the tip 2a. Specifically, the setting unit 210 sets the distance from the tip 2a (attachment position 16a) to each of the plurality of reflectors 100, and the direction of each of the plurality of reflectors 100 as viewed from the tip 2a (attachment position 16a).

Next, the control device 3 causes the robot arm 2 to operate by reproducing the off-line teaching data which is generated in advance by off-line teaching (step S106). Specifically, the control device 3 controls the robot arm 2 to reach the target position which is set in advance by off-line teaching. At this time, the control device 3 stops the robot arm 2 in each operation step (for example, an operation step N). Further, the control device 3 transmits, to the arithmetic unit 30, an instruction to measure the present position and the present posture in the operation step N (step S108). The measurement instruction unit 304 of the arithmetic unit 30 instructs the measuring device 20 to measure the present position and the present posture of the tip 2a in the operation step N according to the measurement instruction from the control device 3. This measurement instruction includes data (target information) indicating the target position and the target posture in the operation step (operation step N). As described later, the arithmetic unit 30 compares the present position and present posture with the target position and target posture, respectively, by using the target information.

The target information is not necessarily included in the measurement instruction. The arithmetic unit 30 may preliminarily store the target information to be used in all operation steps. In this case, the measurement instruction may include an identifier for each operation step, and the arithmetic unit 30 may extract the target information corresponding to the identifier for each operation step.

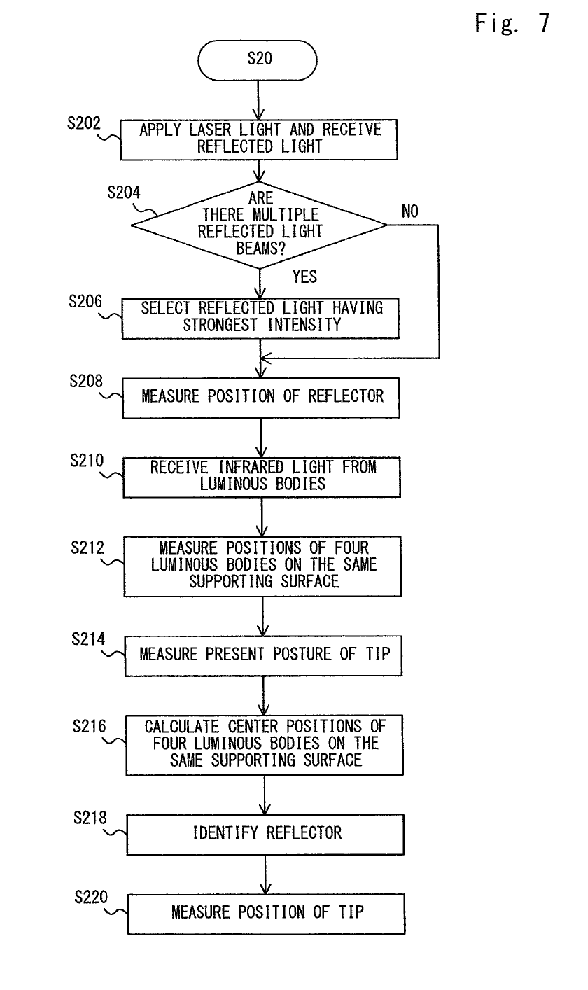

The measuring device 20 measures the present position and the present posture of the tip 2a of the robot arm 2 in the operation step N according to the measurement instruction (step S20). The measurement process in step S20 will be described below with reference to FIG. 7.

FIG. 7 is a flowchart showing the measurement process (S20) according to the first exemplary embodiment. In the following description, assume that the measurement process in S20 is performed by the measuring device 20. However, one or more steps in the measurement process of S20 may be performed by the arithmetic unit 30.

First, the measuring device 20 irradiates the measuring instrument 10 (reflector 100) with the laser beam La, and receives the reflected light Lb from the reflector 100 (step S202). Specifically, the laser light source 202 applies the laser beam La to the reflector 100. The reflected laser light receiving unit 204 receives the reflected light Lb from the reflector 100.

Next, the measuring device 20 determines whether there are a plurality of reflected light beams Lb (step S204). Since the measuring instrument 10 is provided with the plurality of reflectors 100, the laser beam La applied from the measuring device 20 may be reflected on two or more reflectors 100 (for example, the reflector 100A and the reflector 100B). In this case, the reflected laser light receiving unit 204 of the measuring device 20 may receive a plurality of reflected light beams Lb with different intensities (sensitivities). Accordingly, the reflected laser light receiving unit 204 (or the laser intensity determination unit 214) of the measuring device 20 determines whether there are a plurality of reflected light beams Lb. If the number of reflected light beams Lb is one (NO in S204), the following process in 5206 can be omitted.

When there are a plurality of reflected light beams Lb (YES in S204), the measuring device 20 selects the reflected light Lb having the strongest intensity (sensitivity) (step S206). In the position measurement using the laser light, the stronger the intensity of the reflected light Lb is, the more the precision of the position measurement improves. Further, if the reflector 100 reflects the laser beam La when the irradiation direction of the laser beam La deviates from the incidence area 110 of the reflector 100, the intensity of the reflected light Lb may decrease. For this reason, the laser intensity determination unit 214 of the measuring device 20 selects the reflected light having the strongest intensity among the received reflected light beams Lb.

Next, the measuring device 20 measures the position of the reflector 100 (which is referred to as “reflector 100X”) that has emitted (reflected) the reflected light Lb (having the strongest intensity) (step S208). Specifically, the reflector position measuring unit 216 of the measuring device 20 measures the position (coordinates x, y, and z) of the reflector 100X by the above-described method. However, at this stage, the measuring device 20 cannot identify which one of the reflectors 100A to 100F corresponds to the reflector 100X. The reflector 100X is identified in the subsequent process. The intensity of the reflected light Lb is an arbitrary parameter indicating a light intensity (sensitivity; reflection intensity). The intensity of the reflected light Lb may be a parameter that can be measured when the laser light is received.

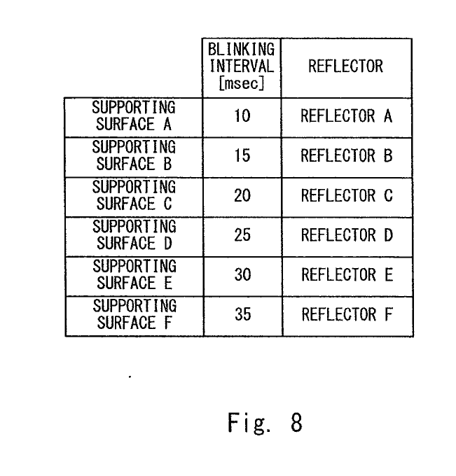

The infrared light receiving unit 206 of the measuring device 20 receives the infrared light I emitted from the luminous bodies 130 (step S210). The infrared light receiving unit 206 is, for example, a stereo camera. Two image pickup elements provided on the right and left sides of the infrared light receiving unit 206 receive the infrared light I. Thus, the infrared light receiving unit 206 can pick up images of the luminous bodies 130 from right and left viewpoints. In this case, each of the luminous bodies 130 causes the infrared light to blink on and off at regular intervals. As shown in FIG. 8, the blinking interval of the infrared light varies depending on the supporting surface 122 on which the luminous bodies 130 are placed.

FIG. 8 is a table showing relationships among the supporting surface 122, the interval of blinking of the luminous body 130 placed on the supporting surface 122, and the reflector 100. The table shown in FIG. 8 is stored in the measuring device 20 (for example, the setting unit 210). A “reflector A” shown in FIG. 8 corresponds to the “reflector 100A”. Similarly, a “reflector B”, a “reflector C”, a “reflector D”, a “reflector E”, and a “reflector F” correspond to the “reflector 100B”, the “reflector 100C”, the “reflector 100D”, the “reflector 100E”, and the “reflector 100F”, respectively. A “supporting surface A” shown in FIG. 8 corresponds to the “supporting surface 122A”. Similarly, a “supporting surface B”, a “supporting surface C”, a “supporting surface D”, a “supporting surface E”, and a “supporting surface F” correspond to the “supporting surface 122B”, the “supporting surface 122C”, the “supporting surface 122D”, the “supporting surface 122E”, and the “supporting surface 122F”, respectively.

For example, the four luminous bodies 130A placed on the supporting surface 122A cause the infrared light to blink on and off at intervals of 10 msec. Similarly, the four luminous bodies 130B placed on the supporting surface 122B cause the infrared light to blink on and off at intervals of 15 msec. The four luminous bodies 130C placed on the supporting surface 122C cause the infrared light to blink on and off at intervals of 20 msec. This enables the measuring device 20 to identify the supporting surface 122 on which the luminous bodies 130 that have emitted the received infrared light I are placed. Further, based on the correspondence relation between the supporting surface 122 and the reflector 100, the measuring device 20 can identify the supporting surface 122 on which the reflector 100 is placed.

The measuring device 20 measures the positions of the four luminous bodies 130 placed on the same supporting surface 122 (step S212). Specifically, the luminous body position measuring unit 220 calculates a parallax based on two images, i.e., the right and left images of each luminous body 130 which are picked up by the infrared light receiving unit 206, thereby measuring the distance from each luminous body 130. Further, the luminous body position measuring unit 220 measures the positions of the four luminous bodies 130 in the reference coordinate system 80 in the same manner as in the method of position measurement of the reflector 100 described above.

In the case of calculating the distance based on the parallax, the precision of the distance measurement is improved by adjusting the resolution according to the distance from the measurement target. In this case, the reflector position measuring unit 216 measures the distance of the reflector 100X. The distance to the luminous body 130 is close to the distance to the reflector 100X. Therefore, the precision of the measurement of the distance to the luminous body 130 can be improved by adjusting the resolution using the distance to the reflector 100.

At this time, the luminous body position measuring unit 220 can identify the supporting surface 122 on which the luminous body 130 whose position is to be measured is placed, based on the blinking interval of the infrared light I. For example, when the measuring instrument 10 faces the measuring device 20 in the posture as shown in FIG. 4, the infrared light receiving unit 206 can pick up images of the four luminous bodies 130A on the supporting surface 122A, the four luminous bodies 130B on the supporting surface 122B, and the four luminous bodies 130C on the supporting surface 122C. The luminous body position measuring unit 220 determines that the positions of the four luminous bodies 130 that blink on and off at intervals of 10 msec correspond to the positions of the four luminous bodies 130A on the supporting surface 122A. Similarly, the luminous body position measuring unit 220 determines that the positions of the four luminous bodies 130 that blink on and off at intervals of 15 msec correspond to the positions of the four luminous bodies 130B on the supporting surface 122B. Similarly, the luminous body position measuring unit 220 determines that the positions of the four luminous bodies 130 that blink on and off at intervals of 20 msec correspond to the positions of the four luminous bodies 130C on the supporting surface 122C.

Next, the measuring device 20 measures the present posture of the tip 2a (step S214). Specifically, based on the position coordinates of the four luminous bodies 130 on the same supporting surface 122, the supporting surface posture measuring unit 222 measures the posture (direction, angle) of the supporting surface 122. For example, the supporting surface posture measuring unit 222 measures the posture of the supporting surface 122A based on the position coordinates of the four luminous bodies 130A. In this case, as described above, the setting unit 210 associates the posture of each supporting surface 122 with the posture of the tip 2a. Accordingly, the tip posture measuring unit 224 measures the present posture (roll, pitch, and yaw) of the tip 2a based on the posture of the supporting surface 122. The supporting surface posture measuring unit 222 may measure the posture of the supporting surfaces 122 corresponding to all the luminous bodies 130 whose images are captured, or may measure the posture of any one of the supporting surfaces 122. The tip posture measuring unit 224 transmits, to the arithmetic unit 30, information indicating the measured present posture (roll, pitch, and yaw) of the tip 2a.

The measuring device 20 calculates the center position of the four luminous bodies 130 (i.e., the position of the intersection of the diagonal lines connecting the four luminous bodies 130) on the same supporting surface 122 (step S216). Specifically, the reflector identifying unit 230 calculates the center position of the four luminous bodies 130 based on the position coordinates of the four luminous bodies 130 on the same supporting surface 122.

Next, the measuring device 20 identifies the reflector 100X whose position is measured in the process of S208 (step S218). Specifically, the reflector identifying unit 230 compares the center position of the four luminous bodies 130 on the same supporting surface 122 with the position of the reflector 100X. When the measuring instrument 10 faces the measuring device 20 as shown in FIG. 4, the reflector identifying unit 230 calculates the center position of the four luminous bodies 130A on the supporting surface 122A, the center position of the four luminous bodies 130B on the supporting surface 122B, and the center position of the four luminous bodies 130C on the supporting surface 122C. The reflector identifying unit 230 determines which one of the three center positions matches the position of the reflector 100X.

The reflector identifying unit 230 identifies, as the reflector 100X, the reflector 100 which corresponds to the supporting surface 122 corresponding to the center position that matches the position of the reflector 100X. For example, when the position of the reflector 100X matches the center position of the four luminous bodies 130A on the supporting surface 122A, the reflector identifying unit 230 identifies the reflector 100A (reflector A) as the reflector 100X.

The position of the reflector 100X need not precisely match one of the three center positions described above. The reflector identifying unit 230 may identify, as the reflector 100X, the reflector 100 which corresponds to the supporting surface 122 corresponding to the center position that is closest to the position of the reflector 100X among the three center positions described above.

Next, the measuring device 20 measures the position of the tip 2a (step S220). Specifically, the tip position measuring unit 232 measures the position of the tip 2a based on the position of the reflector 100 (for example, the reflector 100A) which is identified in the process of S218 and reflects the reflected light Lb having the strongest intensity. More specifically, in the process of 5214, the supporting surface posture measuring unit 222 measures the posture of the supporting surface 122 (for example, the supporting surface 122A) corresponding to the identified reflector 100 (for example, the reflector 100A). The posture of the supporting surface 122 (for example, the supporting surface 122A) corresponds to the posture (direction) of the reflector 100 (for example, the reflector 100A). Accordingly, the tip position measuring unit 232 measures the position of the tip 2a based on the position and posture of the reflector 100 (for example, the reflector 100A). The tip position measuring unit 232 transmits, to the arithmetic unit 30, information indicating the measured present position (x, y, and z) of the tip 2a.

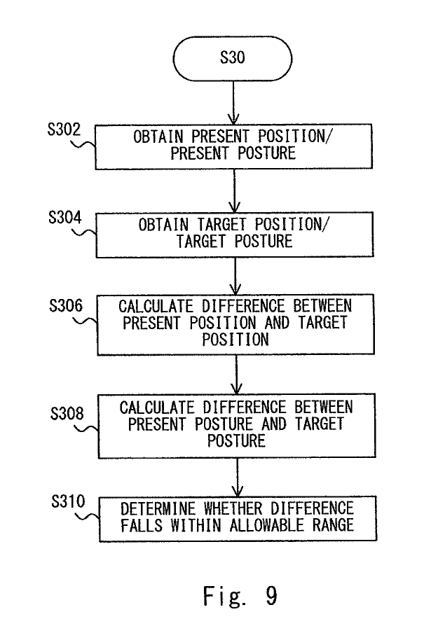

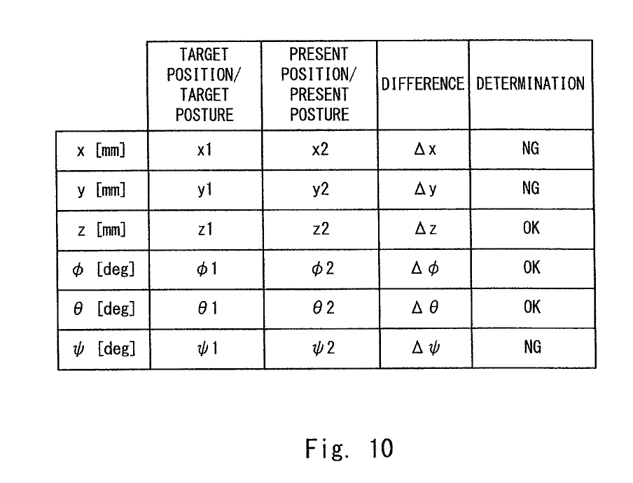

Returning to the description of the position correction process shown in FIG. 6, the arithmetic unit 30 compares the present position and the present posture of the tip 2a, which are measured by the measuring device 20, with the target position and the target posture of the tip 2a in the operation step N (step S30). The comparison process in S30 will be described below with reference to FIGS. 9 and 10.

FIG. 9 is a flowchart showing the comparison process (S30) according to the first exemplary embodiment. FIG. 10 illustrates the comparison process results. First, the comparison unit 310 of the arithmetic unit 30 obtains information indicating the measured present position and present posture of the tip 2a from the measuring device 20 (step S302). Further, the comparison unit 310 obtains target information indicating the target position and the target posture from the measurement instruction unit 304 (step S304).

The comparison unit 310 calculates the difference between the present position and the target position (step S306). At this time, the comparison unit 310 calculates a difference Ax (mm) between a coordinate x2 (mm) of the present position and a coordinate x1 (mm) of the target position. Similarly, the comparison unit 310 calculates a difference Δy (mm) between a coordinate y2 (mm) of the present position and a coordinate y1 (mm) of the target position. Further, the comparison unit 310 calculates a difference Δz (mm) between a coordinate z2 (mm) of the present position and a coordinate z1 (mm) of the target position.

Also, the comparison unit 310 calculates the difference between the present posture and the target posture (step S306). At this time, the comparison unit 310 calculates a difference Δφ (deg) between a roll φ2 (deg (degrees)) of the present posture and a roll φ1 (deg) of the target posture. Similarly, the comparison unit 310 calculates a difference Δθ (deg) between a pitch θ2 (deg) of the present posture and a pitch θ1 (deg) of the target posture. Further, the comparison unit 310 calculates a difference Δψ (deg) between a yaw ψ2 (deg) of the present posture and a yaw ψ1 (deg) of the target posture.

Next, the difference determination unit 312 of the arithmetic unit 30 determines whether the differences (Δx, Δy, Δz, Δφ, Δθ, and Δψ) fall within an allowable range (step S310). For example, the allowable range of the position differences (Δx, Δy, and Δz) is less than ±0.3 mm, and the allowable range of the posture (angle) differences (Δφ, Δθ, and Δψ) is less than ±0.5 deg. However, the allowable ranges are not limited to these ranges. In the example shown in FIG. 10, Δx, Δy, and Δψ are determined to be “NG” (i.e., outside the allowable range), and Δz, Δφ, and Δθ are determined to be “OK” (i.e., within the allowable range).

Returning to the description of the position correction process shown in FIG. 6, the difference determination unit 312 determines whether all the differences fall within the allowable range (“OK”) (step S110). As shown in the example of FIG. 10, if any one of the differences is outside the allowable range (NO in S110), the arithmetic unit 30 calculates a correction amount according to the difference and gives the control device 3 an instruction to set the calculated correction amount (step S120). Specifically, when the correction amount calculation unit 314 gives the robot arm 2 an instruction to set the target position and the target posture corresponding to the off-line teaching data, the correction amount calculation unit 314 calculates a correction amount so that the present position and the present posture match the target position and the target posture, respectively, in the real machine. The correction amount instruction unit 316 gives the control device 3 an instruction to set the calculated correction amount.

The control device 3 causes the robot arm 2 to operate according to the instructed correction amount (step S122). The process of S108 to S110 for the operation step N is carried out again. Specifically, the control device 3 stops the robot arm 2 in the operation step N and transmits an instruction to perform the measurement (S108). The measuring device 20 measures the present position and the present posture of the tip 2a again in the operation step N (S20). The arithmetic unit 30 compares the present position and the present posture of the tip 2a with the target position and the target posture of the tip 2a, respectively, again in the operation step N (S30). When any one of the differences is outside the allowable range (NO in S110), the position correction process is carried out again.

When all the differences fall within the allowable range (YES in S110), the position correction process in the operation step (operation step N) is completed, and the operation step proceeds to the subsequent operation step N+1 (step S130). At this time, the arithmetic unit 30 notifies the control device 3 that the position correction process in the operation step N has been completed. At this time, the control device 3 determines whether all the operation steps have been completed or not (step S132). If all the operation steps have been completed (YES in S132), that is, if there is no “subsequent operation step N+1”, the control device 3 notifies an operator that all the operation steps have been completed (step S134). Accordingly, the operator dismounts the measuring device 20 and the measuring instrument 10 (step S136). On the other hand, if not all the operation steps have been completed (NO in S132), that is, if there is the “subsequent operation step N+1”, the control device 3 controls the robot arm 2 to operate in the subsequent operation step N+1. Then, the position correction process for the operation step N+1 is performed in the same manner as described above.

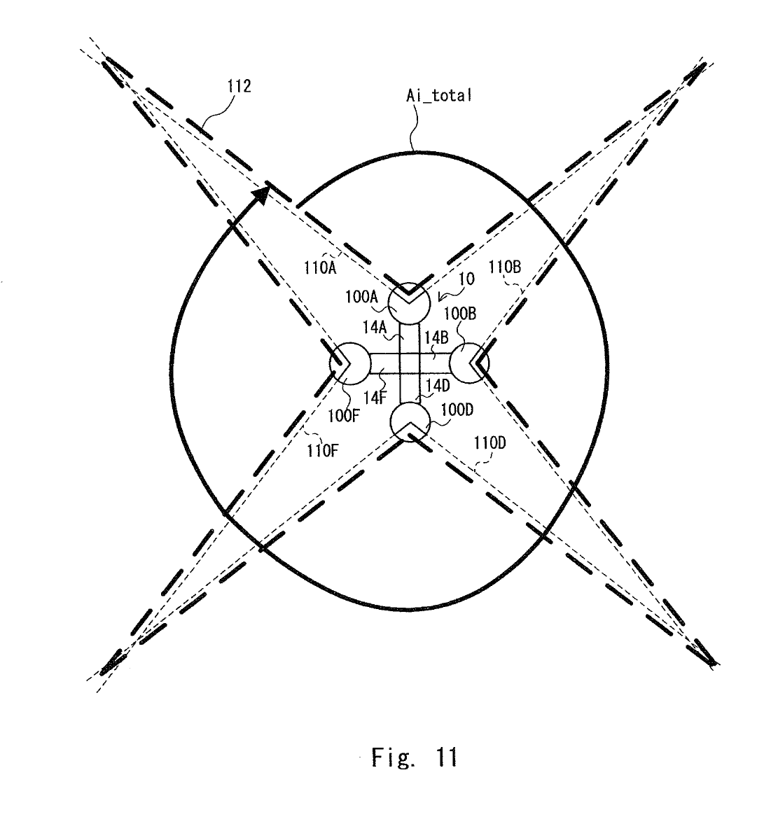

FIG. 11 is a diagram for explaining an area in which the laser beam La can be made incident on the entire measuring instrument 10 according to the first exemplary embodiment. FIG. 11 is a plan view as viewed from the side of the reflector 100 C shown in FIG. 2. As shown in FIG. 11, an angle Ai_total (indicated by a thick arrow) of a combined incidence area 112 (indicated by a thick dashed line) which is obtained by combining an incidence area 110A of the reflector 100A, an incidence area 110B of the reflector 100B, an incidence area 110D of the reflector 100D, and an incidence area 110F of the reflector 100F is 360 degrees. In other words, the combined incidence area 112 includes all directions around the measuring instrument 10 in the plan view as viewed from the side of the reflector 100C shown in FIG. 2. The same is true of the plan view as viewed from the side of the reflector 100A shown in FIG. 2 and the plan view as viewed from the side of the reflector 100B shown in FIG. 2.

Accordingly, the area (combined incidence area) obtained by combining the incidence areas 110 of the plurality of reflectors 100 covers all directions around the measuring instrument 10. With this configuration, the measuring instrument 10 can receive the laser beam La from the measuring device 20, regardless of the posture of the robot arm 2. Further, the incidence area 100 of each reflector 100 is an area in which the precision of the position measurement can be maintained. Accordingly, in the first exemplary embodiment, the position of the robot arm 2 can be measured, regardless of the posture of the robot arm 2, while maintaining the precision of the position measurement.

### Modified Examples

The present invention is not limited to the exemplary embodiment described above, and can be modified as appropriate without departing from the scope of the invention. For example, in the above exemplary embodiment, the robot arm 2 is used for production of vehicles, but the teaching system 1 according to the exemplary embodiment can be applied to any products other than vehicles.

In the above exemplary embodiment, the reflector 100 is irradiated with laser light so that the measuring device 20 can measure the position of the reflector 100 (tip 2a). However, light other than laser light can be used for the measuring device 20 to irradiate the reflector 100 with light, as long as it is possible to perform the position measurement.

Further, in the above exemplary embodiment, the blinking interval of the luminous bodies 130 is used to identify the supporting surface 122 (reflector 100). However, the method for identifying the supporting surface 122 (reflector 100) is not limited to the method using the blinking interval of the luminous bodies 130. For example, the supporting surface 122 (reflector 100) may be identified based on the color of the luminous bodies 130. In this case, there is no need for the luminous bodies 130 to emit light. Markers of different colors may be simply applied to the respective supporting surfaces 122. A minimum number (i.e., any number equal to or greater than three) of luminous bodies 130 (or marks, etc.) with which the posture (direction) of the supporting surface 122 can be measured may be placed on one supporting surface 122. Furthermore, in the above exemplary embodiment, the luminous bodies 130 are provided on each supporting surface 122. However, the location of each luminous body 130 is not limited to this. For example, the luminous bodies 130 may be provided around the mirror portion 102 of the reflector 100. In other words, there is no need to identify the supporting surface 122 so as to identify the reflector 100.

The above exemplary embodiment does not exclude a case where the incidence areas 110 of the plurality of reflectors 100 overlap each other. Specifically, for example, the incidence area 110 of the reflector 100A and the incidence area 110 of the reflector 100B may overlap each other. In this case, the laser beam La can be made incident on both the reflector 100A and the reflector 100B within the incidence area 110. Further, the measuring device 20 can receive the plurality of reflected light beams Lb from both the reflector 100A and the reflector 100B. Also in such a case, the precision of the position measurement can be improved by selecting the reflected light Lb having the strongest intensity in the process of S206 in the above exemplary embodiment.

The measuring instrument 10 including the plurality of reflectors 100 need not be able to reflect the laser beams La from all directions (all the laser light beams La from arbitrary directions). For example, in the example shown in FIG. 2, the incidence area 110 of the reflector 100F may not face the measuring device 20 depending on the working area of the robot arm 2. In other words, the laser beam La may not be made incident from the direction indicated by the arrow F. In this case, the reflector 100F may be omitted. Thus, no reflector is provided at the location that does not face the measuring device 20 due to limitations of the working area of the robot arm 2. Consequently, the number of the reflectors 100 provided at locations unnecessary for the position measurement can be reduced, which leads to a reduction in equipment cost.

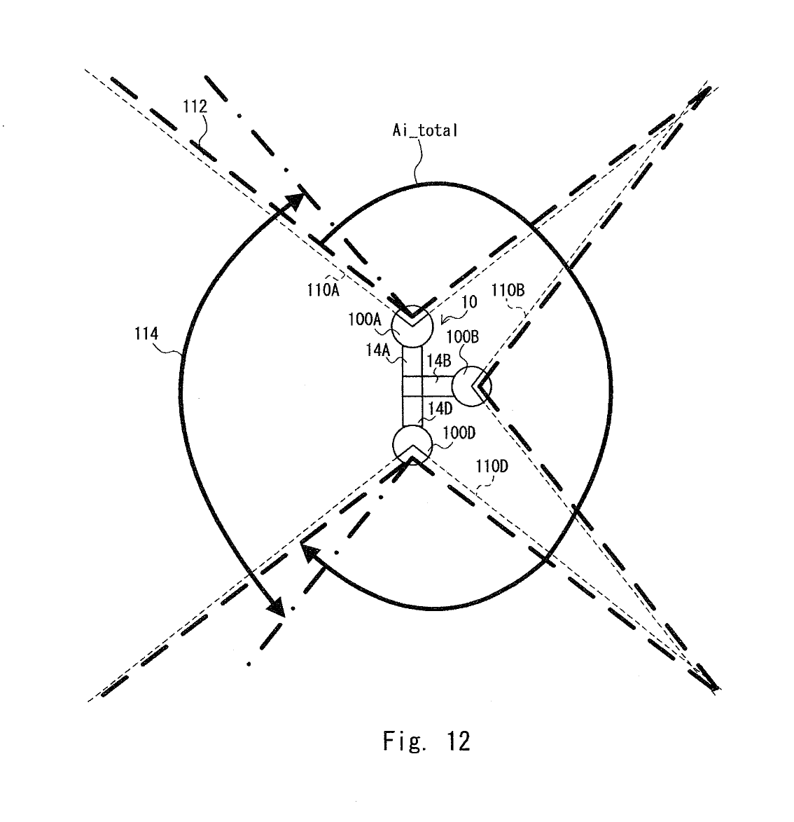

FIG. 12 is a diagram for explaining an area in which the laser beam La can be made incident on the entire measuring instrument 10 according to a modified example. FIG. 12 is a plan view as viewed from the side of the reflector 100C shown in FIG. 2. In the modified example, the working area of the robot arm 2 is limited, which makes it difficult for the tip 2a to take any posture. In the example shown in FIG. 12, the robot arm 2 operates so that the incidence area 110A of the reflector 100A, the incidence area 110B of the reflector 100B, and the incidence area 110D of the reflector 100D face the measuring device 20 in the plan view as viewed from the side of the reflector 100C shown in FIG. 2. At this time, in the example shown in FIG. 12, there is an excluded area 114 (indicated by a thick dashed-dotted line) in which the measuring instrument 10 (the incidence area 110 of the reflector 100) cannot be set in the direction of the measuring device 20 due to limitations of the working area of the robot arm 2. In this case, the robot arm 2 does not operate so that the incidence area 110 of the reflector 100F shown in FIG. 2 in the measuring instrument 10 placed on the tip 2a faces the measuring device 20.

Accordingly, the measuring instrument 10 according to this modified example has a configuration in which the reflector 100F is removed from the measuring instrument 10 shown in FIG. 2. Thus, in this modified example, as shown in FIG. 12, the reflector 100F and the incidence area 100F are omitted from the configuration shown in FIG. 11. In this case, as shown in FIG. 12, the angle Ai_total (indicated by a thick arrow) of the combined incidence area 112 (indicated by a thick dashed line) which is obtained by combining the incidence area 110A of the reflector 100A, the incidence area 110B of the reflector 100B, and the incidence area 110D of the reflector 100D is less than 360 degrees. The combined incidence area 112 includes at least all directions excluding the excluded area 114. In this case, the robot arm 2 operates so that the incidence area 110A of the reflector 100A, the incidence area 110B of the reflector 100B, and the incidence area 110D of the reflector 100D face the measuring device 20. In other words, in the plan view as viewed from the direction indicated by the arrow C shown in FIG. 2, the combined incidence area 112 includes an area in which the measuring instrument 10 faces the measuring device 20 according to the operation of the robot arm 2. The same is true of the plan view as viewed from the side of the reflector 100A shown in FIG. 2 and the side view as viewed from the side of the reflector 100B shown in FIG. 2.

Thus, when there is the excluded area 114 in which the measuring instrument 10 cannot be set in the direction of the measuring device 20 due to limitations of the working area of the robot arm 2, the area (combined incidence area) obtained by combining the incidence areas 110 of the respective reflectors 100 covers at least all directions around the measuring instrument 10, excluding the excluded area (excluded area 114). In other words, the combined incidence area 112 covers an area excluding at least a part of the excluded area 114 in which the incidence area 110 of the reflector 100 cannot be set in the direction of the measuring device 20 due to limitations of the working area of the robot arm 2. With this configuration, any one of the plurality of reflectors 100 of the measuring instrument 10 can receive the laser beam La from the measuring device 20 even when the robot arm 2 takes any possible posture within the limitations of the working area of the robot arm 2. Further, the incidence area 110 of each reflector 100 is an area in which the precision of the position measurement can be maintained. Thus, also in the modified example, the position of the robot arm 2 can be measured, regardless of the posture of the robot arm 2, while maintaining the precision of the position measurement. As shown in FIG. 12, the excluded area 114 and the combined incidence area 112 may overlap each other.

In the above exemplary embodiment, the measuring instrument 10 includes six reflectors 100, which makes it possible to reflect laser light from all directions. However, the number of the reflectors 100 is not limited to six. The number of the reflectors 100 can be increased or decreased, as needed, according to the magnitude of the angle Ai of the incidence area 110 of each reflector 100. When the angle Ai of the incidence area 110 is large, the number of the reflectors 100 may be decreased (to, for example, four). When the angle Ai of the incidence area 110 is small, the number of the reflectors 100 may be increased (to, for example, eight). For example, when the angle Ai of the incidence area 110 is in a range from 190 degrees to +105 degrees with respect to the center of the incidence area 110 (i.e., Ai=180 degrees to 210 degrees), two reflectors 100 may be provided. Specifically, in the configuration shown in FIG. 2, the measuring instrument 10 may include only the reflector 100A and the reflector 100 D which is located on the opposite side of the reflector 100A. That is, the reflectors 100B, 100C, 100E, and 100F may be omitted.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A positioning measurement system that measures a position of a measurement target of a robot arm, the positioning measurement system comprising:
a measuring instrument including a plurality of reflectors, the measuring instrument being provided on the measurement target of the robot arm; and
a measuring device that measures the position of the measurement target of the robot arm by using reflected light on the reflectors, the reflected light being obtained after irradiation light applied to the reflectors is reflected, wherein
the plurality of reflectors each reflect, toward the measuring device, the irradiation light applied from the measuring device located in a direction within a predetermined incidence area, and the measuring instrument is provided with the plurality of reflectors in such a manner that central directions of the incidence areas of the reflectors are different from each other, and
an area obtained by combining the incidence areas of the plurality of reflectors covers all directions around the measuring instrument, or covers an area excluding at least a part of an area in which the incidence area of each of the reflectors cannot be set in the direction of the measuring device due to limitations of a working area of the robot arm.

2. The position measurement system according to claim 1, wherein when two or more of the plurality of reflectors reflect the irradiation light, the measuring device measures the position of the measurement target by using the reflected light having the strongest intensity among a plurality of reflected light beams.

3. The position measurement system according to claim 1, wherein the measuring device measures the position of each of the reflectors by using reflected light from the reflectors, identifies the reflector whose position is measured, and measures the position of the measurement target according to a positional relationship between the identified reflector and the measurement target.
